(19) United States
(12) Patent Application Publication
(10) Pub. No.: US 2026/0064089 A1
(43) Pub. Date: Mar. 5, 2026

(54) BUILDING AUTOMATION MONITORING USING ARTIFICIAL INTELLIGENCE SUPPORTED BY RULES AND/OR ANALYTICS

(71) Applicant: Siemens Industry, Inc., Alpharetta, GA (US)

(72) Inventors: Robert Hafernik, Austin, TX (US); Tyrell Vaughn, Manchaca, TX (US); Marcus Boerkei, Spicewood, TX (US); Stephen Henigman, Mundelein, IL (US)

(73) Assignee: Siemens Industry, Inc., Alpharetta, GA (US)

(21) Appl. No.: 18/819,211

(22) Filed: Aug. 29, 2024

(51) Int. Cl. G05B 13/02; G05B 23/02

(52) U.S. Cl. CPC G05B 13/027; G05B 23/0245; G05B 2223/02

(57) ABSTRACT

For monitoring a building automation system, an artificial intelligence may be used to prioritize, diagnose, and/or provide cost estimates. For ease of interaction, a large language model (LLM) may be used. For operation of the LLM, a prompt requesting assistance is generated. The prompt includes context. Rather than providing the quite voluminous time series data, the context uses the faults and statistics. A processor adds this context to a prompt generated for input to the LLM. Based on the context and prompt, the LLM may rapidly and/or regularly provide accurate diagnosis, prioritization, and/or cost estimates for monitoring building automation. Due to the prompt and context, plain text information assisting in understanding and solving problems in building automation is output without a need for an expert.

### BACKGROUND

The present embodiments relate to building automation. Building automations systems have many components for heating, ventilation, and cooling (HVAC), electrical metering, safety, and/or other operations. These components are interconnected and controlled. The controllers and sensors generate a large amount of data (e.g., time series data) about operation of the different components. Where multiple buildings are involved, even more data is generated. A building management system uses a fault detection and diagnostics (FDD) system to analyze the data and identify any faults in operation. The faults may be presented to a user for correction. It may be difficult to diagnose and prioritize the faults, especially where multiple buildings are involved.

The building management system or another monitoring system may aggregate statistics about performance of the building automation system. The statistics may include average energy usage, environmental statistics (e.g., average temperature), average health of components, and/or other statistics. These aggregated statistics may assist in prioritization but may not provide a direct indication of prioritization and little diagnostic information.

Experts may analyze the faults, time series data, and aggregated statistics for diagnosis and prioritization. This takes time, leading to poor operation of the building automation system for a longer time and/or added costs. Experts may be unavailable. A manager of the building automation system may not be an expert, necessitating hiring a service or consultant.

### SUMMARY

Systems, methods, and non-transitory computer readable storage media storing instructions (program code) are provided for monitoring a building automation system. An artificial intelligence may be used to prioritize, diagnose, and/or provide cost estimates. For ease of interaction, a large language model (LLM) or other artificial intelligence (AI) may be used. For operation of the LLM, a prompt requesting assistance is generated. The prompt includes context. Rather than providing the quite voluminous time series data, the context uses the faults and statistics. A processor adds this context to a prompt generated for input to the LLM. Based on the context and prompt, the LLM may rapidly and/or regularly provide accurate diagnosis, prioritization, and/or cost estimates for monitoring building automation. Due to the prompt and context, plain text information assisting in understanding and solving problems in building automation is output without a need for an expert.

In a first aspect, a method is provided for monitoring a building automation system. Exceptions to rules (e.g., faults) in operation of the building automation system and information about an aggregation of the operation of the building automation system are generated. The exception and information are added as context to a prompt for analysis. The prompt requests analysis of the building automation system. A large language model is queried with the prompt including the context. The analysis created by the large language model is output in response to the prompt.

In a second aspect, a method is provided for monitoring in a building automation system. A rules engine executed by a processor for a building management system detects abnormal performance (e.g., fault) of the building automation system. The processor of the building management system aggregates performance statistics of the building automation system. Context of a prompt for a large language model is populated. The prompt is for monitoring the building automation system. The context is the abnormal performance and the performance statistics. The prompt with the populated context is stored in a queue for querying a large language model.

In a third aspect, a building automation monitoring system is provided. A building management system is configured to generate a list of faults in operation of a building automation system and to generate statistics for the operation of the building automation system. A processor is configured to populate context in a large language model prompt. The context is populated with the list of faults and the statistics. A memory is configured to store the prompt as populated with the context.

Any one or more of the aspects or concepts summarized above or in the Illustrative Embodiments below may be used alone or in combination. The aspects or concepts described for one Illustrative Embodiment or aspect may be used in other embodiments or aspects. The aspects or concepts described for a method or system may be used in others of a system, method, or non-transitory computer readable storage medium.

These and other aspects, features, embodiments, and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 is a flow chart diagram of one implementation of a method for monitoring a building automation system;

FIG. 2 illustrates example exception context;

FIG. 3 illustrates example statistics context;

FIG. 4 illustrates example additional context;

FIG. 5 illustrates an example prompt;

FIG. 6 illustrates an example response from a LLM;

FIG. 7 is a block diagram of one implementation of a building monitoring system; and

FIG. 8 is a block diagram of an example LLM.

### DETAILED DESCRIPTION OF EMBODIMENTS

AI, such as LLM or other machine-learned generative model, provides diagnosis, prioritization, and/or cost estimates for monitoring building automation. The rapid, plain text response from AI may assist in fixing, prioritization of fixes, and decision for whether to fix, even where the manager of the building automation system is not an expert. AI is used to assist fixing problems that are hard to diagnose and prioritize.

To provide the desired response from AI, such as an LLM, a proper prompt and context is provided. Simply providing AI for building automation monitoring may shift the burden from diagnosis and prioritization by an expert to prompt and context creation by an expert. Rather than placing that burden on a user (manager of the building automation), the context may be generated and populated by a processor based on existing information gathering systems. Faults from the building management system are included in the context without including too much data in the form of time series data. Statistics from tracking or aggregation programs are included in the context. Automatic context population of a pre-configured prompt allows for prompt generation without or with minimal user burden.

The summary output by the AI allows the user to focus on solutions rather than identifying solutions. By providing plain text output, non-expert users and even expert users may more easily understand issues and/or act on recommendations.

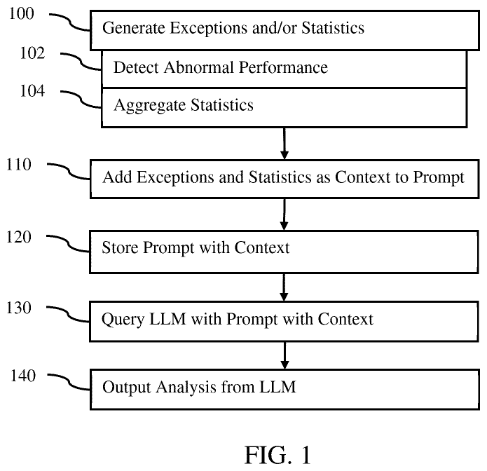

FIG. 1 shows an example implementation of a method for monitoring a building automation system. Software tools are used to reduce the data burden for generating a prompt. The context for the prompt uses identified exceptions (faults) rather than time series data from which exceptions are identified. Statistics provide further context for the prompt. The prompt may then be used to query an LLM, which outputs an analysis for the monitoring of the building automation system.

The method is performed in the order shown (e.g., following arrows or numerical), but other orders may be used. For example, acts 102 and 104 are performed in any order, such as reverse order.

Additional, different, or fewer acts may be provided. For example, acts 130 and 140 are not provided in an implementation for generating the context or prompt without application by the LLM. As another example, act 120 is not provided. In another example, acts for adding other context are provided.

The method is performed by a building automation system, building management system, server, and/or processor. For example, a computer of a building automation system, building management system, or a remote server performs acts 100-120. A separate processor (e.g., server hosting an LLM) performs act 130. Act 140 is performed with a display, such as a display of a computer executing a building automation management system. Other devices, circuits, or equipment may be used.

In act 100, a processor generates exceptions to rules in operation of the building automation system and information about an aggregation of the operation of the building automation system. This context is generated by data analysis, access to a database, receipt over a computer network, or other generation. In one implementation, the context is generated by applications or programs used by or in building automation.

Various information is generated as context to be used for an LLM prompt. Acts 102 and 104 are directed to two types of information. Additional, different, or fewer sources may be provided.

In act 102, a rules engine (e.g., a FDD engine) executed by a processor for a building management system and/or building automation system generates faults (e.g., exceptions). The building automation system includes panels, controllers, sensors, coolers, heaters, meters, speakers, lights, switches, and/or other components. These components normally operate according to settings. Sensors may monitor operation. The operation generates time series data or readings. The building management system receives the data and identifies any abnormal operation. The FDD or rules engine applies limits, tolerances, and/or other operational parameters to identify when one or more components are operating incorrectly. Faults are identified. For example, an exception is detected where air from a cooler is not cool despite the cooler running. As another example, an exception is detected where a fan speed is zero or different than the set fan speed. Faults or exceptions detected as abnormal performance of components are reflected in the time series data of the building automation system. The FDD or rules engine identifies the faults in normal operation.

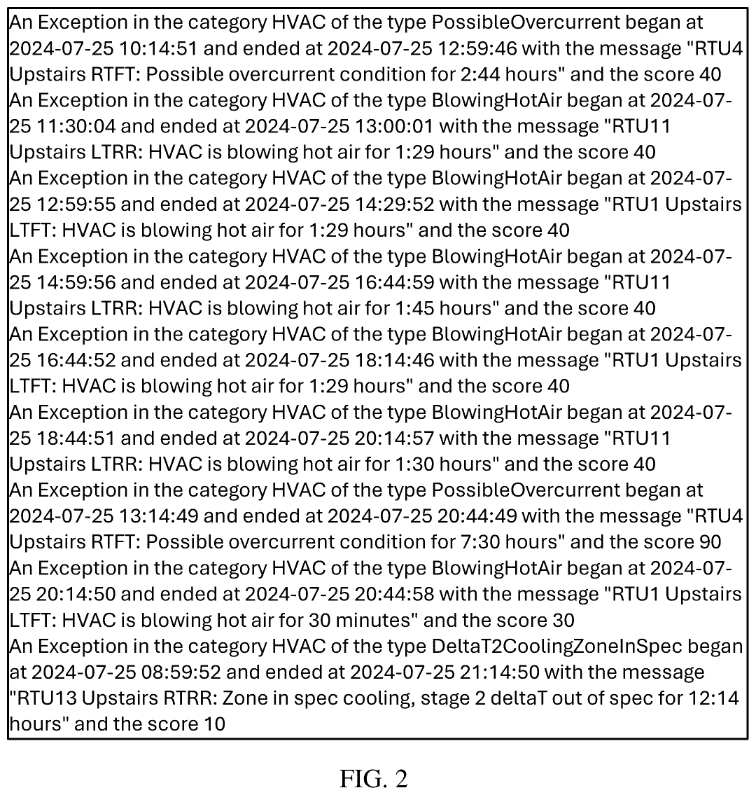

The rules engine lists the faults. FIG. 2 shows an example. Different terms and criteria may be used to describe a given fault. The fault may include various information, such as the time, setting, and actual performance. In the example of FIG. 2, the fault includes a category, type or sub-category, begin and end time, message characterizing the fault, and a score reflecting fault severity. The fault includes an identification of the component or components involved, such as in the message. Additional, different, or less information may be included. For example, information about the cause, description, and/or severity of the faults is added.

A given organization (e.g., Company X) may have a building management system for managing operation of one or more buildings and corresponding building automation systems. The building management system gathers data from the building automation system(s), such as time series data output by panels. The building management system includes a rules-based system (e.g., rules engine or program) for FDD that detects faults in the operation of the equipment in the building (e.g., HVAC units that aren't cooling, fans that aren't blowing, sensors that aren't sensing, etc.). The output of the FDD engine is a list of faults.

In act 104, the processor of the building management system aggregates performance statistics of the building automation system. The building management system tracks performance of the building automation system. Other processors may aggregate, such as server or computer of a service or manufacturer.

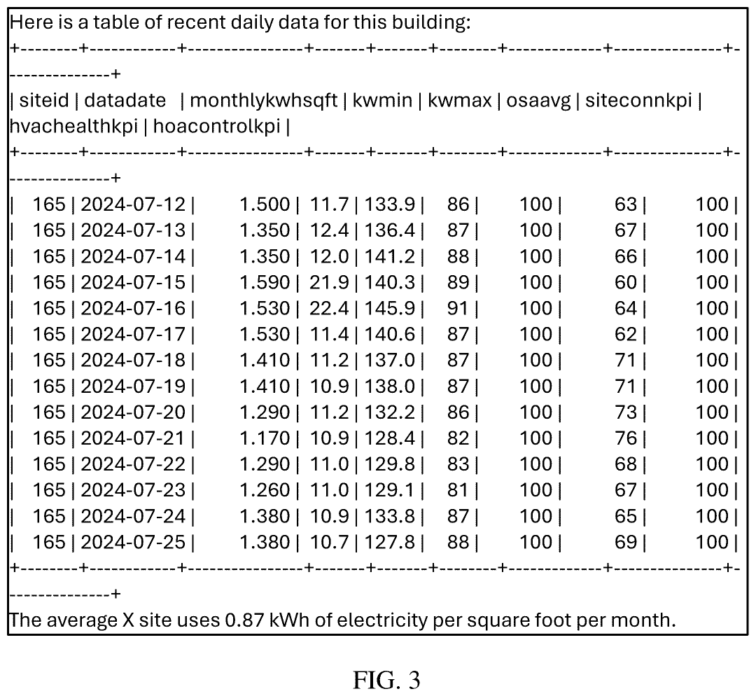

Rather than a violation of a set point, limit, or tolerance, the statistics are about level of performance over a time or period. For example, an average energy usage (e.g., average kWh by day or week) and/or time where a component is disconnected over a period. The statistics may be a %, average, minimum, maximum, mean, median, and/or another measure of performance. In one implementation, the statistics are kilowatt hours used on a date, kWh per square foot usage normalized to one month, maximum kilowatts for the day, average outside air temperature, connectivity of the site to the internet as a percentage of the day, percentage of the time the system was able to control lighting circuits, average health of HVAC units for the day as a percentage (100% is perfectly healthy), and percent of time the HVAC units were in communication with the system. FIG. 3 shows an example by day for a site (building or building automation system) over a two-week period. Additional, different, or fewer statistics may be used. Different periods may be used.

In act 100, the context is generated for one or more buildings. A building automation system may control one or more buildings. Different building automation systems may be used by an organization to control different buildings. The context is gathered for one building or complex. In other implementations, the context is gathered for multiple buildings or complexes. The context for each building may be generated as separate datasets or combined.

In the examples used herein, the building management system manages all the buildings. In other implementations, separate building management systems are provided for separate buildings. The context by building is gathered by the processors (e.g., computers or servers) for the building management systems. Alternatively, a separate processor (e.g., computer or server) accesses data from building management systems and/or other sources of building data to generate the context. For example, a server or workstation gathers exceptions and statistics from different building automation systems or management systems.

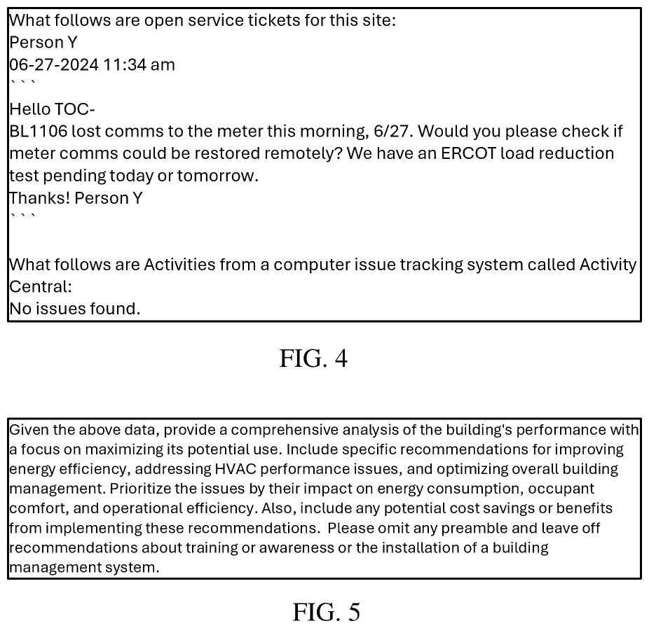

Other information may be generated for context. For example, any tickets or request for correction of building automation, user comments, user priorities, building automation system characteristics (e.g., types of devices), location of building, and/or past problems or solutions are generated. The information is gathered or looked-up from a database and included as context. FIG. 4 shows an example. A service ticket for the building automation system from Person Y is included. FIG. 4 also shows including activities for changes or fixes that occurred for the building automation system.

In act 110, a processor adds the exception, statistics information, and/or other generated data as context to a prompt for analysis. The processor is the same processor that generated the context. Alternatively, the processor(s) generating the context transmit the context to another processor, such as a server or computer. This other processor adds the context to the prompt.

The prompt is a prompt for monitoring and analysis of the building automation system. The prompt is a textual prompt requesting analysis by a LLM so is a prompt for the LLM.

The prompt is pre-configured. Prompt engineering may be used to identify a combination of context content and prompt wording that results in the desired diagnosis, prioritization, cost estimate, and/or other goal for the output analysis. The text for the request (e.g., question or order) to be input to the LLM is used in a template. The template includes locations for different context. The template is standard.

The template sets or has fields for the information to be used in the prompt. Any of various types of information may be used. For example, the prompt template includes one or more instructions to the LLM (prompt), a field or fields for the context, fields for term and/or acronym definitions, and a request. The instructions and the request relate to the purpose, such as informing the LLM what it will be given as the instruction and asking for analysis. Other formats for the template may be used.

FIG. 5 shows an example prompt as plain text. The prompt provides instructions, limitations, and a request.

A user may alter the prompt. Different prompts may be provided for different goals and/or situations. The appropriate prompt and corresponding template are selected by the user. The processor then populates the context.

In one implementation, the prompt is for diagnosis of problems with the building automation system, prioritization of the problems, and cost estimates for the problems (e.g., cost to fix and/or cost to not fix). The user or a processor selects the template. For example, the processor generates the prompt by selecting the prompt template with a standard textual prompt and adds context. The template is filled. Data mining, searching, look-up, or another process extracts the information to populate the template. By using the template, the information is reformatted as defined by the template. The processor instantiates the prompt using the prompt template. The processor automatically populates the prompt with the context. The processor that generated the context or another processor populates.

The processor populates a context portion of the prompt with the context for the building automation system. The context for an AI prompt is built from the results of the FDD analysis, statistics on performance, and a list of other facts about the building and the automation equipment (e.g., service tickets, user comments, service procedures, energy usage, and so on). This context also includes the priorities customers have previously expressed for various types of issues and other customer-specific instructions.

The exceptions are added as context. The exceptions are summaries of abnormal operation. Rather than adding all the data generated by the building automation system in a period, the faults identified from that data are added. This may limit the amount of data provided as context. The time series data from the building automation system is not included in the context or only included where reflecting an identified fault or exception. For example, the raw data from the building is not presented to the AI. This data can be very voluminous and would be expensive for the AI to digest. Also, the building's equipment exists in the real world and is subject to physics and the control system for the building. A rules-based FDD system can be tuned to detect faults much more cheaply than AI processing given the variety of building automation systems. Only after the relatively simple processing by the rules system is the AI to be involved for the complex task of prioritization, summarizing, and/or cost estimation.

Definitions of terms used in the exceptions are added. Alternatively, the definitions are part of the template.

The processor adds the statistics as context. The context is populated with aggregated statistics for the building automation system. Definitions of acronyms and/or terms used for the statistics may be added as context or are part of the template.

The processor may add other context. For example, a location of the building automation system is added. Information about that location may be added, such as weather information and/or building schedule. User comments, user priorities in issues, past fixes, types of components used in the building automation system, type of building automation system, characteristics of building automation, and/or other information may be added as context. Priority or ranking information may be given, such as statements about the most important and/or least important concerns. Problem descriptions, possible causes, and possible fixes may be described. Some context may be part of the default template, such as the term definitions, explanations, acronym definitions, priority statements, problem descriptions with causes and fixes, and any other information applicable regardless of the building and corresponding building automation system.

FIGS. 2-4 show an example context added to a prompt. FIG. 5 shows an example prompt. Other information may be included. Below is a further example of context and prompt together using the examples of FIGS. 1-5:

“The information below is about a building that has the Site Controls Energy and Building Management system installed. This system monitors and controls many aspects of the building's systems, such as lighting, HVAC, energy usage and various sensor data. The Site Controls system is also an energy management system. All of the information in this context comes from this system, unless otherwise noted.”

“This building is Company X number 1106, located at NNNN XXX Rd, Somewhere, State zip. It has 39589 square feet.”

“This site does not have refrigeration units.”

“Important note: The biggest problem at this site is its poor HVAC performance.”

“An “RTU” is a Rooftop Unit, which is a type of HVAC unit on the roof of a building. “UH” means Unit Heater, a small heater located in a particular space. “CES” is a type of HVAC unit designed specifically for grocery store applications. “VAV” is a Variable Air Volume HVAC system. “WIF” is a walk-in freezer. “WIC” is a walk-in cooler. “OSL” refers to outside light and “OSA” refers to outside air temperature. “IO” refers to an input or output to the system and the number following it refers to a particular I/O board and the number after a dash refers to a slot on the board. Zendesk is a system used by support personnel to create tickets detailing problems that need correction. When Zendesk tickets are Quotes, they are price quotes for services. When Zendesk tickets are Dispatch, they are regarding the dispatch of a technician to the site.

“Here is a table of recent daily data for this building:

| siteid | datadate | monthlykwhsqft | kwmin | kwmax | osaavg | siteconnkpi | hvachealthkpi | hoacontrolkpi |
|---|---|---|---|---|---|---|---|---|
| 165 | 2024 Jul. 12 | 1.500 | 11.7 | 133.9 | 86 | 100 | 63 | 100 |
| 165 | 2024 Jul. 13 | 1.350 | 12.4 | 136.4 | 87 | 100 | 67 | 100 |
| 165 | 2024 Jul. 14 | 1.350 | 12.0 | 141.2 | 88 | 100 | 66 | 100 |
| 165 | 2024 Jul. 15 | 1.590 | 21.9 | 140.3 | 89 | 100 | 60 | 100 |
| 165 | 2024 Jul. 16 | 1.530 | 22.4 | 145.9 | 91 | 100 | 64 | 100 |
| 165 | 2024 Jul. 17 | 1.530 | 11.4 | 140.6 | 87 | 100 | 62 | 100 |
| 165 | 2024 Jul. 18 | 1.410 | 11.2 | 137.0 | 87 | 100 | 71 | 100 |
| 165 | 2024 Jul. 19 | 1.410 | 10.9 | 138.0 | 87 | 100 | 71 | 100 |
| 165 | 2024 Jul. 20 | 1.290 | 11.2 | 132.2 | 86 | 100 | 73 | 100 |
| 165 | 2024 Jul. 21 | 1.170 | 10.9 | 128.4 | 82 | 100 | 76 | 100 |
| 165 | 2024 Jul. 22 | 1.290 | 11.0 | 129.8 | 83 | 100 | 68 | 100 |
| 165 | 2024 Jul. 23 | 1.260 | 11.0 | 129.1 | 81 | 100 | 67 | 100 |
| 165 | 2024 Jul. 24 | 1.380 | 10.9 | 133.8 | 87 | 100 | 65 | 100 |
| 165 | 2024 Jul. 25 | 1.380 | 10.7 | 127.8 | 88 | 100 | 69 | 100 |

“The average Company X site uses 0.87 kWh of electricity per square foot per month.”

“Where “siteid” is the database id of the site, “datadate” is the date of the data, “kwh” is kilowatt hours used on the date, “monthlykwhsqft” is kwh per square foot usage normalized to one month, “kwmax” is maximum kilowatts for the day, “osaavg” is average outside air temperature, “siteconnkpi” is the connectivity of the site to the internet as a percentage of the day, “hozcontrolkpi” is percentage of the time the system was able to control lighting circuits, “hvachealthkpi” is the average health of HVAC units for the day as a percentage (100% is perfectly healthy), “dzccommskpi” is percent of time the HVAC units were in communication with the system.”

“When kwh or kwhsqft is increasing, it means the site's overall energy use is increasing. When kwmax is increasing it means some new load or combination of loads is being powered on the site. When kwmin is increasing, it means that some power-consuming device is probably running at night.”

“The following exceptions were created, based on data from the site. Each exception includes a category. The categories are defined as follows:

The Data category refers to network communications with each device and important for the operation of the building management system but not for the building itself. The Comms category refers to communications from the internet to each building site, which is very important. The Ems category refers to exceptions related to the energy management system and these exceptions effect the energy used by the building. The HardwareFault category refers to sensors or devices that are not performing properly due to a poor connection or a faulty device. The Humidity category refers to humidity within the building. The HVAC category refers to exceptions found in the HVAC units within the building. The highest priority exceptions in this category are “BlowingHotAir” and any that indicate the air being supplied is not cool or warm enough, usually with a reference to DeltaT. The Milestone category refers administrative actions taken that may effect building performance. The OSL category refers to Outside Light detection which can effect scheduling of outside lights and the amount of electricity they use. The Outputs category refers to outputs from the control system which usually control lighting contactors and the contactors can be ON or OFF or AUTO, with AUTO meaning controlled by the building management system. The Refrigeration category refers to refrigeration units in the store. The Security category refers to the building's security system, which may be armed, disarmed or alarming depending on the situation. For each exception, a score of 0 means “trivial” while score of 100 is as bad as it gets. In other words, the severity of an exception is based a score, going from 0 for not severe to 100 for very severe.”

“An Exception in the category HVAC of the type PossibleOvercurrent began at 2024 Jul. 25 10:14:51 and ended at 2024 Jul. 25 12:59:46 with the message “RTU4 Upstairs RTFT: Possible overcurrent condition for 2:44 hours” and the score 40″

“An Exception in the category HVAC of the type BlowingHotAir began at 2024 Jul. 25 11:30:04 and ended at 2024 Jul. 25 13:00:01 with the message “RTU11 Upstairs LTRR: HVAC is blowing hot air for 1:29 hours” and the score 40″

“An Exception in the category HVAC of the type BlowingHotAir began at 2024 Jul. 25 12:59:55 and ended at 2024 Jul. 25 14:29:52 with the message “RTU1 Upstairs LTFT: HVAC is blowing hot air for 1:29 hours” and the score 40″

“An Exception in the category HVAC of the type BlowingHotAir began at 2024 Jul. 25 14:59:56 and ended at 2024 Jul. 25 16:44:59 with the message “RTU11 Upstairs LTRR: HVAC is blowing hot air for 1:45 hours” and the score 40″

“An Exception in the category HVAC of the type BlowingHotAir began at 2024 Jul. 25 16:44:52 and ended at 2024 Jul. 25 18:14:46 with the message “RTU1 Upstairs LTFT: HVAC is blowing hot air for 1:29 hours” and the score 40″

“An Exception in the category HVAC of the type BlowingHotAir began at 2024 Jul. 25 18:44:51 and ended at 2024 Jul. 25 20:14:57 with the message “RTU11 Upstairs LTRR: HVAC is blowing hot air for 1:30 hours” and the score 40″

“An Exception in the category HVAC of the type PossibleOvercurrent began at 2024 Jul. 25 13:14:49 and ended at 2024 Jul. 25 20:44:49 with the message “RTU4 Upstairs RTFT: Possible overcurrent condition for 7:30 hours” and the score 90″

“An Exception in the category HVAC of the type BlowingHotAir began at 2024 Jul. 25 20:14:50 and ended at 2024 Jul. 25 20:44:58 with the message “RTU1 Upstairs LTFT: HVAC is blowing hot air for 30 minutes” and the score 30″ “An Exception in the category HVAC of the type

DeltaT2CoolingZonelnSpec began at 2024 Jul. 25 08:59:52 and ended at 2024 Jul. 25 21:14:50 with the message “RTU13 Upstairs RTRR: Zone in spec cooling, stage 2 deltaT out of spec for 12:14 hours” and the score 10″

“An Exception in the category HVAC of the type DeltaT2CoolingZoneNotSpec began at 2024 Jul. 25 20:44:58 and ended at 2024 Jul. 25 21:14:50 with the message “RTU1 Upstairs LTFT: Zone out of spec cooling, stage 2 deltaT issue for 29 minutes” and the score 10″

“An Exception in the category HVAC of the type DeltaT2CoolingZoneInSpec began at 2024 Jul. 25 08:29:53 and ended at 2024 Jul. 25 21:14:51 with the message “RTU6 Sales CNT: Zone in spec cooling, stage 2 deltaT out of spec for 12:44 hours” and the score 10″

“An Exception in the category HVAC of the type DeltaT2CoolingZonelnSpec began at 2024 Jul. 25 09:59:31 and ended at 2024 Jul. 25 21:14:52 with the message “RTU2 Upstairs CNTFT: Zone in spec cooling, stage 2 deltaT out of spec for 11:15 hours” and the score 10″

“An Exception in the category HVAC of the type DeltaT2CoolingZoneInSpec began at 2024 Jul. 25 09:29:59 and ended at 2024 Jul. 25 21:14:58 with the message “RTU8 Sales LTRR: Zone in spec cooling, stage 2 deltaT out of spec for 11:44 hours” and the score 10″

“An Exception in the category HVAC of the type DeltaT2CoolingZonelnSpec began at 2024 Jul. 25 08:30:01 and ended at 2024 Jul. 25 21:14:59 with the message “RTU12 Upstairs CNTRR: Zone in spec cooling, stage 2 deltaT out of spec for 12:44 hours” and the score 10″

“An Exception in the category HVAC of the type PossibleOvercurrent began at 2024 Jul. 25 20:59:55 and ended at 2024 Jul. 25 21:14:59 with the message “RTU4 Upstairs RTFT: Possible overcurrent condition for 15 minutes” and the score 20″

“An Exception in the category HVAC of the type DeltaT2CoolingZoneInSpec began at 2024 Jul. 25 09:59:28 and ended at 2024 Jul. 25 21:29:52 with the message “RTU9 Sales CNTRR: Zone in spec cooling, stage 2 deltaT out of spec for 11:30 hours” and the score 10″

“An Exception in the category HVAC of the type DeltaT2CoolingZoneInSpec began at 2024 Jul. 25 08:14:53 and ended at 2024 Jul. 25 21:29:53 with the message “RTU5 Sales LTFT: Zone in spec cooling, stage 2 deltaT out of spec for 13:15 hours” and the score 10″

“An Exception in the category HVAC of the type BlowingHotAir began at 2024 Jul. 25 21:14:50 and ended at 2024 Jul. 25 21:29:53 with the message “RTU1 Upstairs LTFT: HVAC is blowing hot air for 15 minutes” and the score 30″ “An Exception in the category HVAC of the type

DeltaT2CoolingZoneNotSpec began at 2024 Jul. 26 08:14:48 and ended at 2024 Jul. 26 08:59:55 with the message “RTU1 Upstairs LTFT: Zone out of spec cooling, stage 2 deltaT issue for 45 minutes” and the score 10″

“An Exception in the category HVAC of the type PossibleOvercurrent began at 2024 Jul. 26 07:45:03 and ended at 2024 Jul. 26 10:29:39 with the message “RTU4 Upstairs RTFT: Possible overcurrent condition for 2:44 hours” and the score 40″

“An Exception in the category HVAC of the type BlowingHotAir began at 2024 Jul. 26 09:15:03 and ended at 2024 Jul. 26 10:44:58 with the message “RTU11 Upstairs LTRR: HVAC is blowing hot air for 1:29 hours” and the score 40″

“The BlowingHotAir exception of category HVAC is described as ‘The supply temperature from this HVAC is high considering the fact that this HVAC should be cooling and has been running for sufficiently long time. HVAC may be working against the other HVAC in the zone and blowing hot air either from outside or heating instead of cooling.” and happens because ‘The HVAC wired incorrectly (heating rather than cooling), the compressors have failed with the outside air damper (or economizer controller) allowing excessive hot outside air into the units supply air stream, or the reversing valve is stuck if the unit is a heat pump.’ and requires the action ‘Call your HVAC technician. If this unit serves a shared space, consider remotely turning off until the HVAC tech arrives.’ to fix it.”

“The DeltaT2CoolingZoneInSpec exception of category HVAC is described as ‘The zone temperature is within the specified range, but stage 2 DeltaT is not within the threshold. This exception occurs after a configured time span when the HVAC is in stage 2 cooling and the zone is meeting the cooling setpoint within a configured threshold. But, the difference between the supply duct temperature and the zone setpoint is greater than a configured maximum delta value. In other words, the cooling stage 2 DeltaT is above a configured threshold.” and happens because ‘The HVAC may not be working as effectively as possible. The HVAC filter or coils may be clogged. Check that the unit is receiving 24 volts of power. Other HVACs may be helping to cool the zone, since the zone temperature is within specifications. If other HVAC units are compensating for this HVAC, it could potentially decrease the lifespan of those other HVACs.’ and requires the action ‘Call your HVAC technician.’ to fix it.”

“The DeltaT2CoolingZoneNotSpec exception of category HVAC is described as ‘The zone temperature is not within the expected range and stage 2 DeltaT is not within the configured threshold. This exception occurs after a configured time span when the HVAC is in stage 2 cooling and the zone is not meeting the cooling setpoint within a configured threshold. In addition, the difference between the supply duct temperature and the zone setpoint is greater than a configured maximum delta value. In other words, the cooling stage 2 DeltaT is above a configured threshold.” and happens because ‘The HVAC may not be working as effectively as possible. The HVAC filter or coils may be clogged. Check that the unit is receiving 24 volts of power.’ and requires the action ‘Call your HVAC technician.’ to fix it.”

“The PossibleOvercurrent exception of category HVAC is described as ‘The zone temperature is not within the expected range, but heating or cooling is not being requested. This exception occurs after a short period of time in which the zone is out of spec but should be heating or cooling. Even though the strategy is not OFF, the DZC doesn't appear to be calling for heating or cooling.” and happens because ‘A likely cause is that the DZC is detecting an overcurrent condition on the thermostat wiring the HVAC. As a result, the DZC does not call for the required heating or cooling to avoid damage to the DZC unit itself. Overcurrent protection is a feature of the latest DZC (DZC-II) and therefore does not apply to older DZC versions.’ and requires the action ‘Check to see if there is an Overcurrent indicator light on the DZC. The indicator light will be labeled “OC” for overcurrent. If the light is on, the DZC has detected an overcurrent condition. For an overcurrent condition, an HVAC technician will need to troubleshoot the HVAC to determine the root cause. Possible causes include damaged or failing fan or compressor contactor coils, but may also include damaged/shorted thermostat wiring.’ to fix it.”

“What follows are open service tickets for this site:
Person Y
Jun. 27, 2024 11:34 am . . .
Hello TOC-
BL1106 lost comms to the meter this morning, 6/27. Would you please check if meter comms could be restored remotely? We have an ERCOT load reduction test pending today or tomorrow.
Thanks! Person Y

“What follows are Activities from a computer issue tracking system called Activity Central: No issues found.”

“Given the above data, provide a comprehensive analysis of the building's performance with a focus on maximizing its potential use. Include specific recommendations for improving energy efficiency, addressing HVAC performance issues, and optimizing overall building management. Prioritize the issues by their impact on energy consumption, occupant comfort, and operational efficiency. Also, include any potential cost savings or benefits from implementing these recommendations. Please omit any preamble and leave off recommendations about training or awareness or the installation of a building management system.”

Other formats, language, context, or prompts may be used. The context may be for any period, such as the last month or week. By including the exceptions and statistics in the context specific to a given building, the LLM is given the information allowing LLM-based response with useful analysis. Other types of information may be included to assist the LLM for more useful analysis.

Similar prompts (e.g., same prompt with building specific context) may be created for different buildings and corresponding building automations systems. One prompt with context (e.g., exceptions and statistical information) from multiple buildings may be used. The LLM may be pre-engineered or prompted to expect separate prompts and corresponding text for different buildings to provide an analysis for all the buildings. Alternatively, separate analysis is provided for each of the buildings.

In act 120 of FIG. 1, the created prompt populated with context for one or more buildings is stored. The created prompt is stored in a memory, such as a memory of the computer, workstation, or server that generated and added the context. The created prompt may be stored in the memory of the server, computer, or workstation hosting the LLM.

The context created for the selected prompt on a given day may be saved so that users can use the context with ad-hoc prompts. Alternatively, the user may extract the context from the created prompt populated with the context.

In one implementation, the created prompt is stored in a queue for querying the LLM. The buffer, database, or another memory used to stage or queue prompts to be considered by the LLM stores the created prompt.

In act 130, a processor queries the LLM with the prompt including the context. The AI, prompted with the pre-configured system prompt(s) populated with context, takes this context and prioritizes the problems, suggests fixes, estimates the costs of not fixing the problems and so on. The AI performs the prompted request.

The processor is the same one used to generate the context and/or add the context to a selected prompt. In another implementation, a separate processor executes the LLM.

The LLM analysis is performed for each created prompt. The analysis may be performed for each building or a sub-set thereof.

The LLM performs the classification in response to input of the prompt. The LLM is any now known or later developed LLM, such as GPT (e.g., GPT-4) by OPENAI, PALM or GEMINI by GOOGLE, XAI by GROK, LLAMA (e.g., LLAMA-3) by META, CLAUDE by ANTHROPIC, DBRX by DATABRICK, or another LLM. In one implementation, the LLM is one exposed or trained on technical data. The technical data may or may not be specific to building automation. For example, GPT-4 was trained on a corpus that includes technical documents. In another implementation, the LMM is not pre-engineered or otherwise trained on building automation materials.

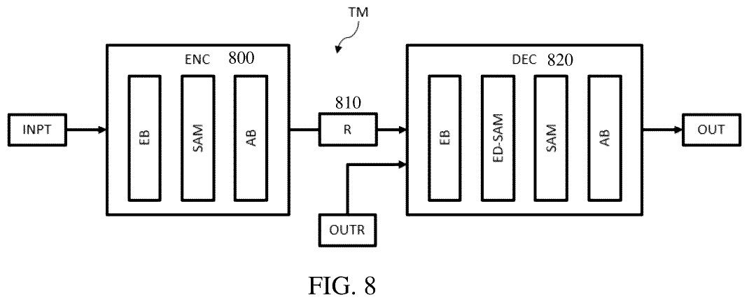

In one approach, the LLM is a transformer formed by a set of neural networks that consist of an encoder and a decoder with self-attention capabilities. In another approach, the LLM is an architecture with transformer decoder-only. As another approach, the LLM uses a recurrent neural network and/or a state space model. The LLM acquires knowledge about syntax, semantics, and ontology in human language corpora through machine learning. LLMs harness language datasets to generate human-like text. When integrated with chain-of-thought prompting, these models connect disparate pieces of information coherently, forming a logical narrative. FIG. 8, described below, shows an example neural network forming an LLM.

In one approach, the LLM is used to answer the prompt without any or further calibration. In another approach, the LLM is prompt-engineered. A database of example contexts, prompts, and desired responses (analysis) are used. The LLM is prompted to review the database to acquire knowledge about semantics, syntax, and terms (e.g., ontology) for the building automation context.

Other types of learning context for LLM may be used. For example, reinforcement learning based on human feedback (RLHF) (e.g., proximal policy optimization) is used. As another example, instruction tuning is used based on bootstrapping from human-generated corrections. In yet another example, a mixture of experts (MoE) process is used.

Once the context is learned or without specific calibration for building automation, the LLM is used for specific created prompts. The LLM is not asked to learn or review context separate from any context in the created prompt. Alternatively, the LLM is asked to study example context beyond the created prompt.

In response to input of the prompt to the LLM, the LLM, executed by the processor, performs the analysis requested by the prompt. The LLM provides a response in plain text.

The analysis by the LLM may be performed regularly or periodically, such as every day for each building and corresponding building automation system. More or less frequent analysis may be prompted, such as once a week or every month. In other implementations, the prompt is created, and the LLM performs the analysis in response to a trigger, such as a user request or occurrence of a given situation (e.g., a type of fault occurs, or the building automation system has a failure). The prompt creation and query to the LLM may occur automatically with no input from a user. It can also be used on the fly by user request.

Below is an example LLM response generated in response to the created prompt provided above. The CLAUDE, without any calibration or preparation, is used as the LLM. The LLM, executed by the processor and in response to the prompt with added context, outputs:

“Based on the provided data, here's a comprehensive analysis of Company X #1106's performance with recommendations for improvement:”

“1. HVAC Performance (Highest Priority): The building's HVAC system is experiencing significant issues, as evidenced by the numerous HVAC-related exceptions. This is likely the primary cause of high energy consumption and poor comfort levels. Recommendations: a) Immediately address the “BlowingHotAir” exceptions for RTU1, RTU11, and potentially others. These units are likely malfunctioning, possibly due to incorrect wiring, failed compressors, or stuck reversing valves. Estimated potential savings: 15-20% on cooling costs. b) Investigate and resolve the “PossibleOvercurrent” issues with RTU4. This could indicate damaged wiring or failing components, which may lead to further damage if not addressed. Estimated savings: 5-10% on HVAC energy consumption and prevention of costly repairs. c) Address the widespread “DeltaT2Cooling” issues across multiple units (RTU1, RTU2, RTU5, RTU6, RTU8, RTU9, RTU12, RTU13). These indicate inefficient cooling, possibly due to clogged filters, dirty coils, or low refrigerant. Estimated savings: 10-15% on cooling costs. d) Consider implementing a regular maintenance schedule for all HVAC units to prevent future issues and maintain efficiency.”

“2. Energy Consumption: The site's energy usage (1.38 kWh/sqft/month) is significantly higher than the average X store (0.87 kWh/sqft/month), indicating substantial room for improvement. Recommendations: a) After addressing HVAC issues, reassess energy consumption. The HVAC improvements alone should bring consumption closer to the average. b) Investigate the cause of high nighttime energy usage (kwmin of 10.7-22.4 KW). This could be due to unnecessary equipment running overnight. Estimated savings: 5-10% on overall energy consumption. c) Implement more aggressive setbacks for HVAC and lighting during closed hours.”

“3. Lighting Optimization: While not explicitly mentioned as an issue, there's potential for improvement in lighting efficiency. Recommendations: a) Upgrade to LED lighting if not already implemented. Estimated savings: 30-50% on lighting energy costs. b) Install occupancy sensors in low-traffic areas to reduce unnecessary lighting usage. c) Optimize outside lighting schedules based on seasonal changes and actual daylight conditions using the OSL (outside light) detection capability.”

“4. Refrigeration: Although not highlighted as a major issue, optimizing refrigeration can yield significant energy savings in retail environments. Recommendations: a) Ensure proper maintenance of walk-in freezers (WIF) and walk-in coolers (WIC), including regular cleaning of condenser coils and checking for air leaks. b) Install strip curtains or auto-closing doors on walk-in units if not already present. c) Optimize defrost cycles and ensure they're not running more frequently than necessary.”

“5. Building Envelope: While not directly mentioned, improving the building envelope can significantly impact HVAC efficiency. Recommendations: a) Conduct an air leakage test and seal any identified leaks. b) Inspect and upgrade insulation where necessary, particularly in the roof area where most heat gain/loss occurs.”

“6. Energy Management System Utilization: Ensure full utilization of the Site Controls Energy and Building Management system. Recommendations: a) Review and optimize HVAC scheduling based on occupancy patterns and outside air temperatures. b) Implement demand response strategies to reduce peak demand charges, particularly important given the mention of an ERCOT load reduction test. c) Use the system's data analytics capabilities to continually monitor and adjust for optimal performance.”

“Prioritized Action Plan: 1. Address critical HVAC issues (BlowingHotAir and PossibleOvercurrent exceptions), 2. Resolve widespread DeltaT2Cooling issues across multiple HVAC units, 3. Investigate and reduce high nighttime energy usage. 4. Optimize lighting systems, 5. Enhance refrigeration efficiency. 6. Improve building envelope, 7. Maximize utilization of the energy management system”

“By implementing these recommendations, the store could potentially reduce its energy consumption by 25-35%, bringing it much closer to the average X store performance. This would result in significant cost savings and improved comfort for occupants. The exact savings will depend on current utility rates and the specific condition of the equipment, but could range from $10,000 to $20,000 annually for a store of this size and current consumption level.”

Other responses may be provided. For example, different LLMs may generate different responses. The response is to the context and prompt. Varying the context and/or prompt may result in a different response.

In act 140, the processor executing the LLM outputs the response. The response is output to a memory, display, and/or interface for communication over a computer network. In one implementation, the response is transmitted to a requesting processor, such as a processor of a building management system.

The analysis created by the LLM is output on a display or speaker. In response to the prompt, a facility manager, building engineer, building owner, Company manager, or other user is provided with the response. The analysis in the response is displayed to the user. For example, the results of this AI analysis are displayed for the building owner on a website or communicated in various ways.

In one implementation, a user interface of a building management system includes a window, link, button, or other selection for viewing the analysis. For example, a notification is provided to the user. The user selects the notification, bringing up the response as plain text for review by the user.

The analysis is displayed on a periodic basis and/or in response to a trigger. The analysis may be provided regularly to the user for decision making.

The response is provided as plain text. A chart, graph, picture, or other generated output by the LLM may be included in the response or be the response. Bullet point or written sentence structure may be used. Any format output by the LLM to communicate the analysis prompted by the created prompt (selected prompt with added context) may be used.

The output analysis is for a single building and corresponding building automation system. Alternatively, the output analysis is for multiple buildings and corresponding building automation system(s). Where the analysis is for multiple buildings, such as different sites for Company X, the analysis may include a prioritization of the buildings. Rather than or in addition to prioritizing problems or solutions for a building, the buildings are prioritized.

In one implementation, a list of buildings with the highest (e.g., top 10) priority is displayed. The LLM is prompted to output a summary for each of the buildings in the prioritization indicating information about the relative prioritization. The user may select a building, which results in display of the analysis for that building. Other user interface and/or display approaches may be used.

The user may interact with the LLM. For example, the prompt is changed and the LLM queried again. As another example, the user inputs a follow-up question to the LLM (e.g., creates their own prompt as a follow up). In response, the LLM generates another response. Any interaction between the user and the LLM may occur based on the prompted response.

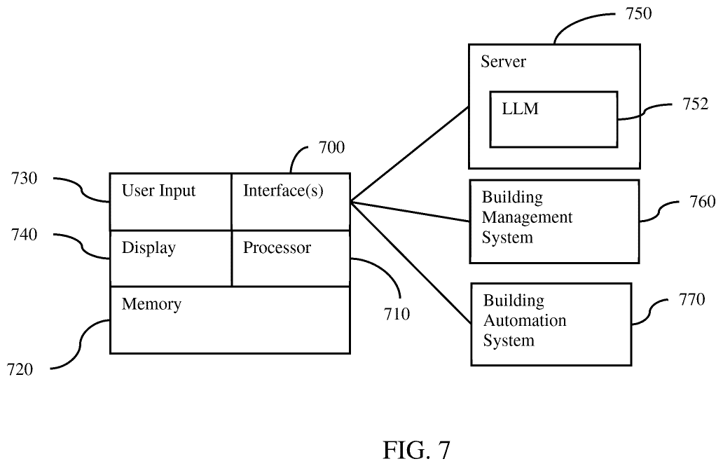

FIG. 7 shows a building automation monitoring system. The building automation monitoring system may form a building automation system or include a building automation system. The monitoring system monitors the building automation system 770. Context from faults and statistics of the building automation system 770 is generated for use in an LLM prompt.

The building automation monitoring system includes the interface or interfaces 700, processor 710, memory 720, user input 730, and display 740. The interface 700, display 740, processor 710, user input 730, and/or memory 720 may be part of a computer, server, workstation, or another system, such as the building automation system 770 or the building management system 760.

The building automation monitoring system may further include a server 750 connected to the interfaces 700 through a computer network. The server 750 hosts the LLM 752. In other implementations, the LLM 752 is hosted locally to the processor 710, such as where the processor 710 is part of a server or where the LLM 752 is implemented on a computer at a manufacturer or manager of the building automation system 770. In other implementations, the processor 710 is part of the building automation system 770, whether local or remote from the building. In yet another implementation, the processor 710 is part of the building management system 760, whether local or remote from the building. The LLM 752 is hosted by the building automation system, the building management system, or on a separate processor.

Additional, different, or fewer components may be provided. For example, a computer network is included for remote application of the LLM based on locally entered input and output results. As another example, additional building automation systems 770 are provided, such as where the processor 710 and/or server 750 are used for a service provided to different building automation systems or a building automation system for multiple buildings. In another example, the building automation system 770, building management system 760, and/or server 750 are not provided.

The building automation system 770 includes heating ventilation air conditioning (HVAC), fire safety, security, and/or other automated components for operating a building. The building automation system 770 may be for one building, one floor, multiple floors of a building, multiple buildings, a facility, and/or a complex. The building automation system 770 may include panels, controllers, sensors, user inputs, actuators, alarms, ducts, heaters, fans, air conditioners, filters, boilers, heat exchangers, supervisor computers, and/or other components.

The building management system 760 may be a computer that is part of or separate from the building automation system 770. The building management system 760 may be implemented on a panel or another processor, whether remote or local to the building automation system 770. The building management system 760 communicates over a computer network with the components of the building automation system 760, such as communicating with panels of the building automation system 760. The building management system 760 may receive time series data indicating the operation of the various components of the building automation system 770. Other information, such as tickets or user comments, may be provided to or stored at the building management system 760.

The building management system 760 executes a program for controlling the building automation system 770. A user interface for reviewing operation and data from the building automation system 770 and/or for changing operation of components of the building automation system 770 may be provided. In one implementation, the processor 710 is part of the building management system 760.

The building management system 760 is configured by program code to generate a list of faults in operation of the building automation system 770 and to generate statistics for the operation of the building automation system 770. In alternative implementations, the statistics are created by another computer, so the building management system 760 generates the statistics by receipt and adding to a prompt.

The interface 700 is shown as one interface, but multiple interfaces may be provided. The interface 700 is a modem, computer network interface, ethernet interface, Wi-Fi, Bluetooth, and/or other computer networking interface for receiving and/or transmitting communications.

The interface 700 is configured by a specification or standard design, controller, and/or by the processor 710. The interface 700 is configured to receive information from the building automation system 770, building management system 760, and/or the server 750.

The processor 710 is a control processor, general processor, digital signal processor, graphics processing unit, application specific integrated circuit, field programmable gate array, artificial intelligence processor or accelerator, digital circuit, analog circuit, combinations thereof, or another now known or later developed device for implementing the LLM 752, creating context, selecting a prompt, populating a prompt with context, and/or displaying analysis from the LLM 752. The processor 710 is part of the server 750, the building management system 760, the building automaton system 770, or a stand-alone computer, server, or workstation. The processor 710 is a single device, a plurality of devices, or a network. For more than one device, parallel or sequential division of processing may be used. Different devices making up the processor 710 may perform different functions or the same function in parallel. For example, the server 750 may be part of the processor 710 where the server 750 hosts the LLM 752 and the processor 710 is part of a computer or workstation for generating the prompt and providing the response to the user. The processor 710 operates pursuant to stored instructions, hardware, and/or firmware to perform various acts described herein.

The processor 710 is configured to generate context. The processor 710 generates faults. For example, the processor 710 executes a rules engine to generate faults. As another example, the processor 710 receives faults from the building management system 760 and generates the faults as context for a prompt.

The processor 710 generates statistics. For example, the processor 710 executes a program to aggregate statistics from available data. As another example, the processor 710 receives statistics from the building management system 760 and/or another source and generates the statistics as context for a prompt.

The processor 710 is configured to populate context in a LLM prompt. Based on a default or selection from the user input 730, a prompt or prompt template including a prompt and other general information is identified. The processor 710 populates the context into the selected prompt. The context populated with the list of faults and the statistics is added to the prompt. The context is for a particular building, buildings, building automation system 770, or building automations systems.

The processor 710 is configured to add the prompt with context to a queue for the LLM 752. The prompt with context is transmitted to the server 750 or provided to the LLM 752. The processor 710 is configured to receive the response from the LLM 752 and generate a user interface or output displaying the response.

The memory 720 is configured by formatting and/or the processor 710 to store information for monitoring the building automation system 770. For example, the memory 720 stores context, a prompt, a prompt populated with context, and/or a responsive analysis. The memory 720 may store the LLM 752. In one implementation, the memory 720 stores the prompt prior to population as one of a plurality of standard prompts for analysis in building automation. The prompts are default requests for analysis.

The memory 720 is an external storage device, RAM, ROM, database, and/or a local memory (e.g., solid state drive or hard drive). The same or different non-transitory computer readable media may be used for the instructions and other data. The memory 720 may store instructions for operating the processor 710 and/or the server 750. The memory 720 may be implemented using a database management system (DBMS) and/or be a hard disk, RAM, or removable media. Alternatively, the memory 720 is internal to the processor 710 (e.g., cache). The memory 720 is formed from one device or a collection of devices, such as different memories storing different types of data.

The instructions for generating context, selecting a prompt, adding context to the prompt, querying the LLM, and outputting the responsive analysis by the processor 710 are provided on non-transitory computer-readable storage media or memories, such as a cache, buffer, RAM, removable media, hard drive or other computer readable storage media (e.g., the memory 720). Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the way the present embodiments are programmed.

The server 750 is a computer, workstation, graphics processing unit, tensor processor, artificial intelligence processor, and/or server card. The server 750 is configured by hardware, firmware, and/or software to implement the LLM 752. Alternatively, the processor 710 implements the LLM 752.

The processor 710 or server 750 is configured to execute the LLM 752 to generate an analysis of the building automation system 770. In response to the LLM prompt, the LLM 752 generates an output.

The user input 730 is a keyboard, buttons, sliders, dials, trackball, mouse, touch pad, touch screen, microphone, and/or another device for user interaction with the processor 710 and/or building automation monitoring system. The user input 730 is part of a graphics user interface for receiving user input, such as user tickets, comments, prioritizations, analyses triggers, or other information. The user input 730 may be configured by the processor 710 and/or hardware to receive inputs for interaction of the user with the LLM 752.

The display 740 is a CRT, LCD, projector, plasma, printer, tablet, smart phone, or another now known or later developed display device for displaying the context, prompt, analysis, and/or other information. The display 740 is configured by loading an image to a display buffer or plane, which image is then displayed on a screen. Other configuration may be provided, such as configuring for display by printing.

In other implementations, the building automation monitoring system includes multiple building automation systems 770 or the building automation system 770 is for multiple buildings. The building management system 760 connects with the multiple buildings or building automation systems 770. The processor 710 is a server, workstation, or computer configured to generate the list and the statistics (context) for the plurality of the building automation systems 770, either as separate context and corresponding prompts (e.g., one created prompt with context) per building or building automation system 770 or as one prompt with context from multiple buildings or building automation systems 770.

FIG. 8 shows an example transformer. The LLM is formed from one or more transformers. In FIG. 8, a schematic representation of a transformer model TM is shown. The transformer model TM is configured to process a prompt as input INPT and return a class as output OUT. The transformer architecture follows an encoder-decoder structure formed from an encoder ENC 800 and a decoder DEC 820. In brief, the task of the encoder ENC 800 is to map an input INPT to a sequence of continuous representations R 810, which is then fed into a decoder DEC 820. The decoder DEC 820 receives the representations R 810 to generate an out-put OUT. The decoder output OUTR at a previous iteration may be input to generate the out-put OUT.

The encoder ENC 800 is generally configured to transform individual data items of the input INPT into a numerical representation R 810. According to some examples, the numerical representation R 810 may take the form of a numerical vector for each data item of the input INPT. The representation R encodes how relevant a particular data item of the input INPT is with regard to other data items in the input INPT. To provide the numerical representation R 810, the encoder ENC 800 may include a plurality of blocks. A first block EB may be configured as an embedding block EB configured to bring the data items into a machine-readable form, the so-called embeddings, while preserving certain relations of the data items such as positional relations. In particular, the embeddings may be numerical vectors. The embeddings are fed into a second block SAB which may be designated as a self-attention block SAB. The self-attention block SAB implements a self-attention mechanism configured to determine how relevant a particular data item of the input INPT is with regard to other data items in the input INPT and modify the embeddings based on this information so as to generate attention vectors. According to some examples, the self-attention block SAB may be realized as neural network with one or more hidden layers. Said neural network may be trained to determine multiple attention vectors by data item and integrate these into one resulting attention vector. With regard to the latter, the self-attention block SAB may be configured to implement an additive or dot-product-based combination of individual attention vectors. The dimension of the attention vectors generated reflects how many data items are being compared in the self-attention block SAB. If, for instance, the self-attention block SAB is configured to compare 768 data items, the self-attention vector may have a dimension of 768 entries. The attention vectors are then fed into an adaptation block AB which is configured to map the attention vectors to a form which is suited for further processing (either by another self-attention block or the decoder or any other downstream processing).

The decoder DEC 820 may generally be configured to map the representation R 810 onto a desired output OUT. The decoder DEC 820 is configured to compute the output OUT based on the representations R 810 provided by the encoder ENC 800 with or without an output OUTR of a previous iteration. Like the encoder ENC 800, the decoder DEC 820 relies on a self-attention mechanism. Specifically, the decoder DEC 820 may include a plurality of blocks. Similar to the encoder ENC 800, a first block EB may be configured as an embedding block EB translating the previous output OUTR into embeddings. The embeddings are input to a self-attention block SAB configured to provide an attention vector of the previous output OUTR based on its embeddings. The attention vectors of the previous output OUTR are input into an encoder-decoder self-attention block ED-SAB together with the representations R 810 as provided by the encoder ENC 800. The encoder-decoder self-attention block ED-SAB is configured to map the representation to the attention vectors of the previous output OUTR so as to regressively improve the previous output OUTR. The output of the encoder-decoder self-attention block ED-SAB may be seen as attention vectors for data items in the input INPT and the vector space of the desired output OUT based on the previous output OUTR. These attention vectors are then fed into an adaptation block AB configured to map the attention vectors to a form suited for further processing (either by another self-attention block or by way of the generation of the final output).

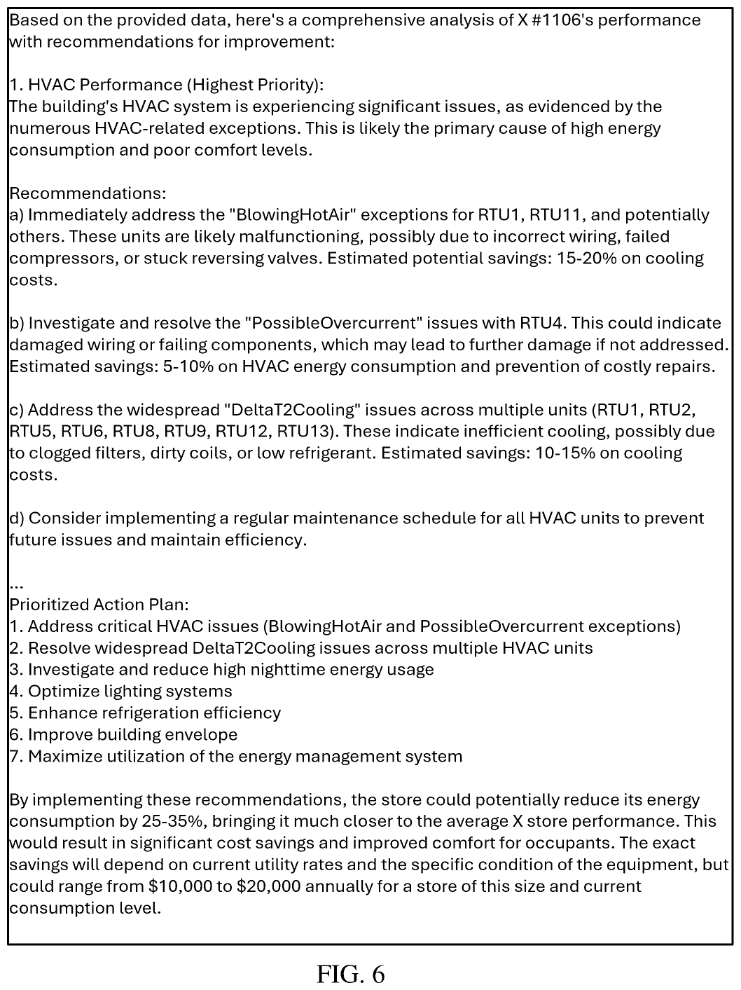

The designation of the distinct blocks EB, SAB, ED_SAB, AB and the number of blocks shown in FIG. 8 is to be construed by way of example and not as a limitation. Specifically, individual blocks EB, SAB, AB may be integrated to form one single block. In particular, all blocks may respectively be a neural network each with a plurality of layers. Moreover, there may be a plurality of stacks of self-attention blocks SAB and adaptation blocks AB in the encoder ENC 800, wherein the last adaptation block provides the final numerical representation R 810. Likewise, there may be a plurality of stacks of encoder-decoder self-attention blocks ED-SAB and adaptation blocks AB in the decoder DEC 820, wherein the last adaptation block AB provides the final output OUT. According to some examples, the decoder structure shown in FIG. 6 may be replaced by a final adaptation block also referred to as “interpreter” configured to directly map the representation of the encoder on one or more learned outputs OUT which are human understandable.

In some instances, the encoders and/or decoders are composed of several corresponding encoding layers and decoding layers, respectively. Within each encoding and decoding layer preferably there is an attention mechanism. The attention mechanism, sometimes denoted as self-attention, relates data items (such as words or pixels) within a series of data items to other data items within said series. The self-attention mechanism for instance allows the model to examine a group of words within a sentence and determine the relative importance of other groups of words within that sentence for the group of words being examined. The encoder, in particular, may be configured to transform the input text into a numerical representation. The numerical representation may be a vector per input token (e.g., per word). The encoder may be configured to implement an attention mechanism so that each vector of a token is affected by the other tokens in the input. In particular, the encoder may be configured such that the representations R 810 resolve the desired output of the transformer network TM.

The decoder, in particular, may be configured to transform an input into a sequence of output tokens. In particular, the decoder may be configured to implement a masked self-attention mechanism so that each vector of a token is affected only by the other tokens to one side of a sequence. Further, the decoder may be auto-regressive meaning in that intermediate results are fed back. According to some examples, the input of the decoder is based on the output of the encoder or equivalent to the output of the encoder. Further, the transformer network may include a classification module configured to map the output of the encoder or decoder to a set of learned outputs.

Training of a transformer model according to some examples may happen in two stages, a pretraining and a fine-tuning stage. In the pretraining stage, a transformer model may be trained on a large corpus of data to learn the underlying semantics of the problem. Such pre-trained transformer models are available for different languages. For certain applications described herein, the fine-tuning may include further training the transformer network with building automation or technical texts. The transformer model according to some examples may learn typical relations and synonyms of building automation expressions.

An advantage of transformer networks is that, due to the attention mechanism, transformer networks can efficiently deal with long-range dependencies in input data. Further, encoders used in transformer networks are capable of processing data in parallel, which saves computing resources in inference. Moreover, decoders of transformer networks, due the auto-regression, are able to iteratively generate a sequence of output tokens with great confidence.

Listed below are various Illustrative Embodiments. The Illustrative Embodiments summarize different combinations of aspects. Other combinations of any of the aspects with any other one or more of the aspects may be provided. Aspects from one type (e.g., method or system) may be used in another type (system or method).
Illustrative Embodiment 1. A method for monitoring in a building automation system, the method comprising: generating exceptions to rules in operation of the building automation system and information about an aggregation of the operation of the building automation system; adding the exception and information as context to a prompt for analysis, the prompt requesting analysis of the building automation system; querying a large language model with the prompt including the context; and outputting the analysis created by the large language model in response to the prompt.
Illustrative Embodiment 2. The method of Illustrative Embodiment 1 wherein generating the exceptions comprises generating a list of faults in the operation of the building automation system, and wherein generating the information comprises generating averages in energy usage and temperature over a period.
Illustrative Embodiment 3. The method of any of Illustrative Embodiments 1-2 wherein generating the exceptions comprises listing the exceptions provided by a rules engine of a building management system, the exceptions provided by the rules engine from time series data, and wherein adding comprises adding the exceptions as the context without adding the time series data to the context.
Illustrative Embodiment 4. The method of any of Illustrative Embodiments 1-3 wherein adding further comprises adding a location of the building automation system, acronym definitions, and term explanations as the context.
Illustrative Embodiment 5. The method of any of Illustrative Embodiments 1-4 wherein adding further comprises adding user comments and/or user priorities in issues as the context.
Illustrative Embodiment 6. The method of any of Illustrative Embodiments 1-5 wherein adding comprises adding the context to the prompt, the prompt being a pre-configured request for the analysis.
Illustrative Embodiment 7. The method of any of Illustrative Embodiments 1-6 wherein adding comprises adding the context to the prompt where the analysis is for diagnosis of problems with the building automation system, prioritization of the problems, and cost estimates for the problems.
Illustrative Embodiment 8. The method of any of Illustrative Embodiments 1-7 wherein adding comprises automatically populating the prompt with the context.
Illustrative Embodiment 9. The method of any of Illustrative Embodiments 1-8 wherein querying comprises querying automatically on a periodic basis, and wherein outputting comprises displaying the analysis on the periodic basis as plain text.
Illustrative Embodiment 10. The method of any of Illustrative Embodiments 1-9 wherein generating comprises generating the exceptions and information for a plurality of buildings, wherein adding comprises adding the exceptions and the information for the plurality of buildings as the context, and wherein outputting comprises outputting the analysis with prioritization of the buildings.
Illustrative Embodiment 11. The method of Illustrative Embodiment 10 wherein outputting comprises outputting with the prioritization including a summary for each of the buildings in the prioritization.
Illustrative Embodiment 12. A method for monitoring in a building automation system, the method comprising: detecting, by a rules engine executed by a processor for a building management system, abnormal performance of the building automation system; aggregating, by the processor of the building management system, performance statistics of the building automation system; populating context of a prompt for a large language model, the prompt being for monitoring the building automation system, the context being the abnormal performance and the performance statistics; and storing the prompt with the populated context in a queue for querying a large language model.
Illustrative Embodiment 13. The method of Illustrative Embodiment 12 wherein detecting comprises detecting faults as the abnormal performance, the faults detected from time series data of the building automation system, and wherein populating the context comprise populating the context with the faults and without the time series data.
Illustrative Embodiment 14. The method of any of Illustrative Embodiments 12-13 wherein aggregating comprises aggregating the performance statistics for energy usage and connectivity.
Illustrative Embodiment 15. The method of any of Illustrative Embodiments 12-14 wherein populating comprises further including location of the building automation system in the context.
Illustrative Embodiment 16. The method of any of Illustrative Embodiments 12-15 wherein populating comprises populating automatically by the processor or another processor.
Illustrative Embodiment 17. A building automation monitoring system comprising: a building management system configured to generate a list of faults in operation of a building automation system and to generate statistics for the operation of the building automation system; a processor configured to populate context in a large language model prompt, the context populated with the list of faults and the statistics; and a memory configured to store the prompt as populated with the context.
Illustrative Embodiment 18. The building automation monitoring system of Illustrative Embodiment 17 wherein the processor is configured to execute the building management system, and wherein memory is configured to store the prompt prior to the population as a default request for analysis of the building automation system.
Illustrative Embodiment 19. The building automation monitoring system of any of Illustrative Embodiments 17-18 further comprising: a server configured to execute a large language model and generate an analysis of the building automation system by the large language model in response to the large language model prompt; and a display configured to display the analysis.
Illustrative Embodiment 20. The building automation monitoring system of any of Illustrative Embodiments 17-19 wherein the building automation system is a first building automation system of a plurality of building automation systems, and wherein the processor comprises a first server configured to generate the list and the statistics for the plurality of the building automation systems.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for monitoring in a building automation system, the method comprising:
generating exceptions to rules in operation of the building automation system and information about an aggregation of the operation of the building automation system;
adding the exception and information as context to a prompt for analysis, the prompt requesting analysis of the building automation system;
querying a large language model with the prompt including the context; and
outputting the analysis created by the large language model in response to the prompt.

2. The method of claim 1 wherein generating the exceptions comprises generating a list of faults in the operation of the building automation system, and wherein generating the information comprises generating averages in energy usage and temperature over a period.

3. The method of claim 1 wherein generating the exceptions comprises listing the exceptions provided by a rules engine of a building management system, the exceptions provided by the rules engine from time series data, and wherein adding comprises adding the exceptions as the context without adding the time series data to the context.

4. The method of claim 1 wherein adding further comprises adding a location of the building automation system, acronym definitions, and term explanations as the context.

5. The method of claim 1 wherein adding further comprises adding user comments and/or user priorities in issues as the context.

6. The method of claim 1 wherein adding comprises adding the context to the prompt, the prompt being a pre-configured request for the analysis.

7. The method of claim 1 wherein adding comprises adding the context to the prompt where the analysis is for diagnosis of problems with the building automation system, prioritization of the problems, and cost estimates for the problems.

8. The method of claim 1 wherein adding comprises automatically populating the prompt with the context.

9. The method of claim 1 wherein querying comprises querying automatically on a periodic basis, and wherein outputting comprises displaying the analysis on the periodic basis as plain text.

10. The method of claim 1 wherein generating comprises generating the exceptions and information for a plurality of buildings, wherein adding comprises adding the exceptions and the information for the plurality of buildings as the context, and wherein outputting comprises outputting the analysis with prioritization of the buildings.

11. The method of claim 10 wherein outputting comprises outputting with the prioritization including a summary for each of the buildings in the prioritization.

12. A method for monitoring in a building automation system, the method comprising:
detecting, by a rules engine executed by a processor for a building management system, abnormal performance of the building automation system;
aggregating, by the processor of the building management system, performance statistics of the building automation system;
populating context of a prompt for a large language model, the prompt being for monitoring the building automation system, the context being the abnormal performance and the performance statistics; and
storing the prompt with the populated context in a queue for querying a large language model.

13. The method of claim 12 wherein detecting comprises detecting faults as the abnormal performance, the faults detected from time series data of the building automation system, and wherein populating the context comprise populating the context with the faults and without the time series data.

14. The method of claim 12 wherein aggregating comprises aggregating the performance statistics for energy usage and connectivity.

15. The method of claim 12 wherein populating comprises further including location of the building automation system in the context.

16. The method of claim 12 wherein populating comprises populating automatically by the processor or another processor.

17. A building automation monitoring system comprising:
a building management system configured to generate a list of faults in operation of a building automation system and to generate statistics for the operation of the building automation system;
a processor configured to populate context in a large language model prompt, the context populated with the list of faults and the statistics; and
a memory configured to store the prompt as populated with the context.

18. The building automation monitoring system of claim 17 wherein the processor is configured to execute the building management system, and wherein memory is configured to store the prompt prior to the population as a default request for analysis of the building automation system.

19. The building automation monitoring system of claim 17 further comprising:
a server configured to execute a large language model and generate an analysis of the building automation system by the large language model in response to the large language model prompt; and
a display configured to display the analysis.

20. The building automation monitoring system of claim 17 wherein the building automation system is a first building automation system of a plurality of building automation systems, and wherein the processor comprises a first server configured to generate the list and the statistics for the plurality of the building automation systems.
